(19) United States
(12) Patent Application Publication
(10) Pub. No.: US 2010/0194124 A1
(43) Pub. Date: Aug. 5, 2010

(54) BELT FOR ELECTROMAGNETIC SUCKER

(75) Inventor: Jacob Benhammou, La Queue-en-Brie (FR)

Correspondence Address: GREENBLUM & BERNSTEIN, P.L.C., 1950 ROLAND CLARKE PLACE, RESTON, VA, 20191, US

(73) Assignee: DIGIT, Pantin (FR)

(21) Appl. No.: 12/445,917

(22) PCT Filed: Oct. 17, 2006
(86) PCT No.: PCT/FR06/02323

§ 371 Date: Apr. 16, 2009

(51) Int. Cl. E05C 19/16; E05C 17/56; H01F 7/06

(52) U.S. Cl. 292/251.5; 29/602.1; 335/278

(57) ABSTRACT

A belt for electromagnetic sucker includes a first substantially U-shaped section, a second substantially U-shaped section, an electromagnetic sucker coupled to at least one of the first and second substantially U-shaped sections, at least one of the first and second substantially U-shaped sections being structured and arranged to be secure to a support, and a connector structured and arranged to secure the first and second substantially U-shaped sections to one another.

The present invention relates to improvements to belts for electromagnetic suckers.

As is known, a sucker is in fact an electromagnet attached at the periphery of an opening and capable, when excited, of retaining a reinforcing plate fixed to the door, or inversely.

In the state of the art, the sucker is fixed in a section, referred to as the belt, which is itself fixed against the support (a wall or a door).

The belt is in the form of a tubular section comprising, on one of its surfaces, an opening that is cut out to enable the sucker to be inserted and attached. This opening is advantageously used to access the other surface of the section and to enable the assembly to be fixed to the support.

Experimentation has shown that this localized fixing is insufficient on lengthy belts and, in this case, that it is necessary to use additional screws extending through the two opposite surfaces of the section, with all the risks that this involves.

The implementation of these belts is not practical because running the electric supply cables poses problems. Indeed, the cables must be connected to the sucker prior to it being fixed in the belt, which involves the following disadvantages:
the length of the cables must be much greater than the length separating the opening for the insertion thereof and the terminals of the sucker, and this length must then be reinserted in the belt;
the positioning of the sucker must be carried out on-site and after connection of the cables;
a connection check-up requires disassembling the sucker.

The belt of the invention, which overcomes these disadvantages, is characterized in that it is constituted by the association of two sections each having a substantially U-shaped cross-section, one of which carries the sucker and comprises means for enabling it to be fixed to the support, whereas the other is adapted to cover the first, means being provided for affixing the two assembled sections to one another.

The present invention will be better understood from the description that follows, with reference to the annexed drawings by way of example only, in which:

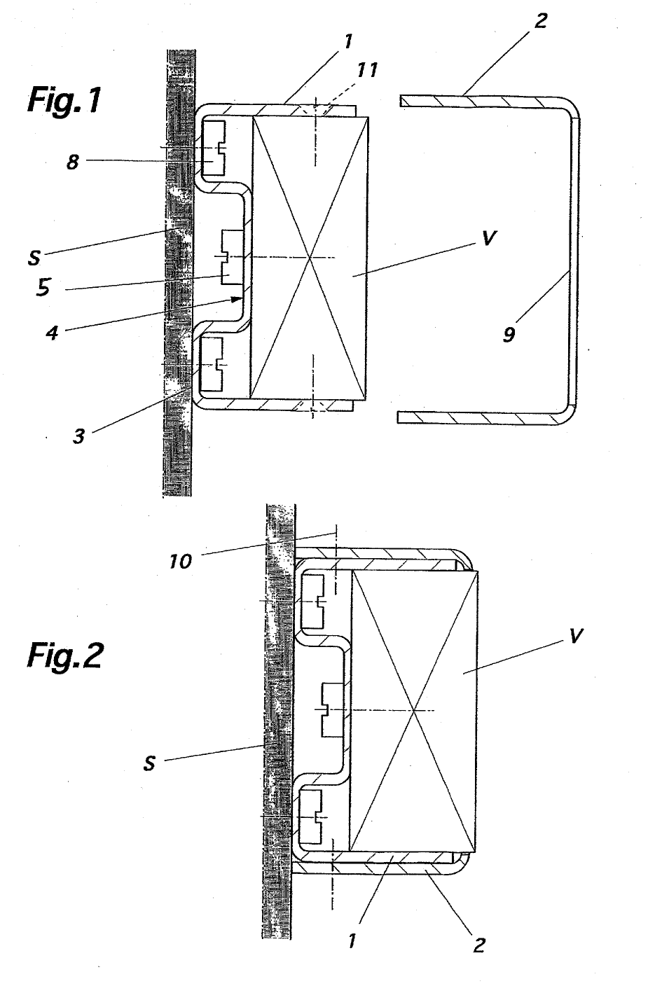

FIG. 1 is a transverse cross-sectional view of a belt according to the invention, while being installed;

FIG. 2 is a view similar to FIG. 1, with the belt installed;

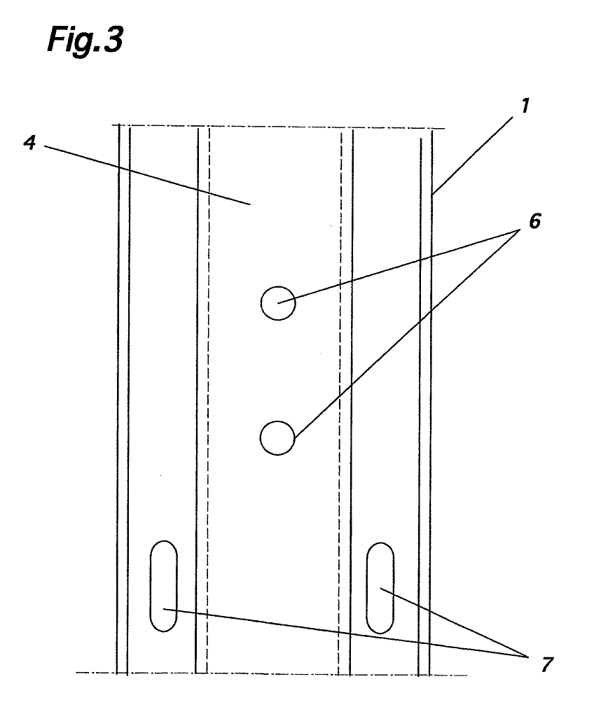

FIG. 3 is a partial view of the section for supporting the sucker.

Referring to the drawings, one sees that the belt is constituted by the association of two sections 1 and 2 having a U-shaped cross-section, section 2 being capable of completely covering section 1.

Section 1 is provided to enable the sucker V to be fixed. According to the invention, the sucker is fixed in the section prior to said section being fixed to the support S. Generally, this fixing is carried out at the factory.

According to one embodiment, the median portion 3 of the section has a longitudinal groove 4, the bottom of which serves as a support for the sucker V held by screws 5 extending through the bottom of said groove which, as shown in FIG. 3, has holes 6.

The median portion 3 has openings 7, which are preferably oblong, for passage of the screws 8 for fixing the section against the support S.

The median portion of section 2 has an opening 9 for passage of the sucker.

After section 1 has been fixed, and the supply cables (not shown) connected thereafter, the assembly is covered by section 2, which acts in the manner of a cap. Any usual means can be used for fixing section 2 to section 1.

Thus, screws, the axes of which are schematically shown at 10 in FIG. 2, can be used. Section 2 can be clipped on section 1.

With respect to fixing the sucker, this can be carried out with screws extending through the wings of section 1, such as those 11 shown in dotted lines in FIG. 1. In this case, it is not necessary that the sucker take support against the bottom of the groove 4.

1-2. (canceled)

3. A belt for electromagnetic sucker comprising:
a first substantially U-shaped section;
a second substantially U-shaped section;
an electromagnetic sucker coupled to at least one of the first and second substantially U-shaped sections;
at least one of the first and second substantially U-shaped sections being structured and arranged to be secure to a support; and
a connector structured and arranged to secure the first and second substantially U-shaped sections to one another.

4. The belt of claim 3, wherein the second substantially U-shaped section is adapted to cover the first U-shaped section.

5. The belt of claim 3, wherein the first substantially U-shaped section comprises a median portion having a longitudinal groove.

6. The belt of claim 3, wherein the first substantially U-shaped section comprises:
a base portion securable to the support; and
two spaced apart members arranged on opposite sides of the electromagnetic sucker.

7. The belt of claim 3, wherein the first substantially U-shaped section comprises:
a base portion securable to the support and to one side of the electromagnetic sucker; and
two spaced apart members arranged on opposite sides of the electromagnetic sucker.

8. The belt of claim 3, wherein the first substantially U-shaped section comprises:
a base portion securable to the support via two connecting areas arranged on opposite sides of a middle connecting area securable to one side of the electromagnetic sucker; and
two spaced apart members securable to opposite sides of the electromagnetic sucker.

9. The belt of claim 3, wherein the second substantially U-shaped section comprises:
a base portion; and
two spaced apart members arranged on opposite sides of the electromagnetic sucker.

10. The belt of claim 3, wherein the second substantially U-shaped section comprises:
a base portion comprising an opening structured and arranged to receive a portion of the electromagnetic sucker; and
two spaced apart members arranged on opposite sides of the electromagnetic sucker.

11. The belt of claim 3, wherein the second substantially U-shaped section comprises:
a base portion comprising an opening structured and arranged to receive a portion of the electromagnetic sucker; and
two spaced apart members securable to two spaced apart members of the first U-shaped section.

12. A method of assembling the belt of claim 3 to a support, the method comprising:
securing the first substantially U-shaped section to a support;
securing the electromagnetic sucker to the first substantially U-shaped section; and
securing the second substantially U-shaped section to the first substantially U-shaped section.

13. A method of assembling the belt of claim 3 to a support, the method comprising:
securing a base portion of the first U-shaped section to a support;
securing a first side of the electromagnetic sucker to a median portion of the first substantially U-shaped section; and
securing two spaced apart members of the second substantially U-shaped section to two spaced apart members of the first substantially U-shaped section.

14. An electromagnet retaining assembly for a door comprising:
a first substantially U-shaped section;
a second substantially U-shaped section; and
an electromagnetic coupled to at least one of the first and second substantially U-shaped sections,
wherein at least one of the first and second substantially U-shaped sections is securable to a support and the first and second substantially U-shaped sections are securable to one another.

15. The assembly of claim 14, wherein the second substantially U-shaped section is adapted to cover the first substantially U-shaped section.

16. The assembly of claim 14, wherein the first substantially U-shaped section comprises a median portion having a longitudinal groove.

17. The assembly of claim 14, wherein the first substantially U-shaped section comprises at least one of:
a base portion securable to the support and two spaced apart members arranged on opposite sides of the electromagnet;
a base portion securable to the support and to one side of the electromagnet and two spaced apart members arranged on opposite sides of the electromagnet; and
a base portion securable to the support via two connecting areas arranged on opposite sides of a middle connecting area that is securable to one side of the electromagnet and two spaced apart members securable to opposite sides of the electromagnet.

18. The assembly of claim 14, wherein the second substantially U-shaped section comprises at least one of
a base portion and two spaced apart members arranged on opposite sides of the electromagnet;
a base portion comprising an opening structured and arranged to receive a portion of the electromagnet and two spaced apart members arranged on opposite sides of the electromagnet; and
a base portion comprising an opening structured and arranged to receive a portion of the electromagnet and two spaced apart members securable to two spaced apart members of the first U-shaped section.

19. A method of assembling the assembly of claim 14 to a support, the method comprising:
securing the first substantially U-shaped section to a support;
securing the electromagnet to the first substantially U-shaped section; and
securing the second substantially U-shaped section to the first substantially U-shaped section.

20. A method of assembling the assembly of claim 14 to a support, the method comprising:
securing a base portion of the first substantially U-shaped section to a support;
securing a first side of the electromagnet to a median portion of the first substantially U-shaped section; and
securing two spaced apart members of the second substantially U-shaped section to two spaced apart members of the first substantially U-shaped section.

21. An electromagnet retaining assembly for a door comprising:
a first substantially U-shaped section;
a second substantially U-shaped section comprising an opening; and
an electromagnetic coupled to at least one of the first and second substantially U-shaped sections and having a portion adapted to project into the opening of the second substantially U-shaped section.

22. The assembly of claim 21, wherein:
the first substantially U-shaped section comprises at least one of:
a base portion securable to the support and two spaced apart members arranged on opposite sides of the electromagnet;
a base portion securable to the support and to one side of the electromagnet and two spaced apart members arranged on opposite sides of the electromagnet; and
a base portion securable to the support via two connecting areas arranged on opposite sides of a middle connecting area that is securable to one side of the electromagnet and two spaced apart members securable to opposite sides of the electromagnet; and
the second substantially U-shaped section comprises at least one of:
a base portion and two spaced apart members arranged on opposite sides of the electromagnet;
a base portion comprising an opening structured and arranged to receive a portion of the electromagnet and two spaced apart members arranged on opposite sides of the electromagnet; and
a base portion comprising an opening structured and arranged to receive a portion of the electromagnet and two spaced apart members securable to two spaced apart members of the first U-shaped section.
